(19) United States
(12) Patent Application Publication
(10) Pub. No.: US 2009/0291262 A1
(43) Pub. Date: Nov. 26, 2009

(54) METHOD AND DEVICE FOR PRODUCING A WINDOW GLAZING EQUIPPED WITH A PROFILED STRIP COMPRISING AN INSERT, AND WINDOW GLAZING OBTAINED

(75) Inventors: Renaud Subra, Dubendorf (CH); Christophe Kleo, Attichy (FR); Fabrice Leroy, Cambronne Les Ribecourt (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/519,842

(22) PCT Filed: Dec. 20, 2007
(86) PCT No.: PCT/FR07/52588

§ 371 Date: Jun. 22, 2009

(30) Foreign Application Priority Data
Dec. 22, 2006 (FR) 0655892

(51) Int. Cl. B32B 3/30; B29C 41/52

(52) U.S. Cl. 428/161; 264/40.1; 425/112; 264/265

(57) ABSTRACT

A method and a device for mass-production of window glazings using nominal data defining a reference window glazing that is curved, and permissible tolerance bands for these nominal data, in which the mass-produced window glazings are each curved and each includes at least one profiled strip including at least one insert by encapsulation. In a production run, for each window glazing of the production run, at least i) the molding cavity of the mold, or ii) the glazed element, or iii) the insert or inserts, is not of a configuration that corresponds to the dimensions for the reference window glazing. The mass-produced window glazings produced have a curvature that corresponds to that of the reference window glazing within the tolerance bands.

The present invention relates to a method for producing a window glazing equipped with at least one profiled polymer strip comprising one (or more) insert(s), this profiled strip being produced by implementing the technique known as encapsulation.

It is known practice in the prior art to position one (or more) insert(s) inside a profiled strip produced by encapsulation. These inserts may be fully incorporated into the material of which the profiled strip is made such that only the point(s) of attachment in the mold projects (project) or may for the most part protrude from the surface of the profiled strip. They can be used to increase the overall rigidity of the window glazing and/or to allow it to be fixed to vehicle bodywork elements and/or alternatively allow accessories to be fixed to the window glazing.

At the present time, when mass-producing a curved window glazing with an encapsulated profiled strip, the window glazing is curved in its final configuration prior to the encapsulation step, that is to say that the window glazing is produced in such a way that, prior to encapsulation, it is of dimensions that it is to have in its as-delivered state ready to be mounted on the vehicle.

However, if the encapsulated window glazing comprises at least one insert then during the encapsulation step, the various elements of which it is composed (the glass substrate, the profiled strip, the insert(s)) are raised from ambient temperature up to a temperature of the order of 80° C. or above 100° C. in a matter of a few seconds, reaching this temperature while the polymeric material is being injected, and are then cooled rapidly in the open air. This being the case, the glass and the inserts, which each have very different coefficients of thermal expansion, change size in a ratio which is not a one-to-one ratio.

When the material of which the profiled strip is made cures, it locks these elements in a position which is not their position of equilibrium at ambient temperature.

During cooling, the glass and the inserts contract, and this contraction leads to deformations within the part. The final curvature of the part is therefore neither that of the glass prior to encapsulation nor the absolutely exact curvature desired, nor that of the inserts, nor even that of the mold. The roofs are then termed self-curved roofs, because they have obtained their own particular curvature.

This phenomenon can also be seen when the window glazing is flat prior to encapsulation: after encapsulation, it displays a certain curvature.

The window glazings may end up more highly curved than desired at certain points and/or less highly curved than desired at others, as the case may be.

The object of the invention is to provide a solution to this problem so that the window glazings delivered ready to mount in the bodywork aperture ultimately display exactly the desired curvature.

Within the meaning of the present invention, the term “curvature” is to be understood as meaning the overall curvature of the window glazing, it being possible for this curvature to be zero overall when the window glazing displays a flat form.

However, the degree of curvature at certain points on the window glazing is greater than at others; the expression “the desired curvature” thus denotes those points on the window glazing where it is of greatest importance that the correct curvature be observed; these include, in particular, the curvature of the window glazing at the points where this curvature lies flush with the bodywork.

Considering that the object of the invention is to attempt the mass-production of window glazings using nominal data defining a reference window glazing which is curved and considering also that this reference window glazing is given with permissible tolerance bands for these nominal data; considering also that the mass-produced window glazings are each curved and each equipped with at least one profiled polymer strip comprising one (or more) insert(s), said profiled strip being produced by encapsulating a glazed element in a mold exhibiting a molding cavity; and further considering that the mass-produced window glazings produced have a curvature which corresponds to that of the reference window glazing, within the tolerance bands; the present invention thus proposes that, for the mass-production of window glazings, for each window glazing of the production run, at least one of the following three elements be not of a configuration that corresponds to the dimensions for the reference window glazing:

i—the molding cavity of the mold, or
ii—the glazed element, or
iii—the insert or inserts.

Thus, in an entirely surprising manner, it is possible to succeed in producing a production run of window glazings which all conform to the reference window glazing within its tolerance bands even though at least some of the hardware used does not conform to that normally used for the reference window glazing.

It is thus possible that, in the production run of window glazings, for each window glazing, the molding cavity of the mold is not of a configuration that corresponds to the dimensions for the reference window glazing.

It is also possible that, in the production run, for each window glazing, the glazed element is not of a configuration that corresponds to the dimensions for the reference window glazing.

It is further possible that, in the production run, for each window glazing the insert or inserts is (are) not of a configuration that corresponds to the dimensions for the reference window glazing.

Furthermore, it is possible to succeed in producing a production run of window glazings which all conform to the reference window glazing within its tolerance bands even though most of the hardware used does not conform to that normally used for the reference window glazing.

It is thus possible that, in the production run, for each window glazing, on the one hand, the molding cavity of the mold and, on the other hand, the glazed element are not of a configuration that corresponds to the dimensions for the reference window glazing.

It is also possible that, in the production run, for each window glazing, on the one hand, the molding cavity of the mold and, on the other hand, the insert or inserts are not of a configuration that corresponds to the dimensions for the reference window glazing.

It is further possible that, in the production run, for each window glazing, at least, on the one hand, the glazed element and, on the other hand, the insert or inserts, are not of a configuration that corresponds to the dimensions for the reference window glazing.

Finally, it is possible to succeed in producing a production run of window glazings which all conform to the reference window glazing within its tolerance bands even though all of the hardware used does not conform to that normally used for the reference window glazing.

It is thus possible that, in the production run, for each window glazing, the molding cavity of the mold, the glazed element and the insert or inserts are none of them of a configuration that corresponds to the dimensions for the reference window glazing.

The present invention also relies on the production of at least one pre-production run, that is to say on the production of at least one collection of prototype window glazings and on using the mean curvature measurements from these prototype window glazings to modify the tooling used and thus make it possible to produce a final production run of window glazings that meets expectations.

The present invention thus also consists in a method for the mass-production of window glazings using nominal data defining a reference window glazing which is curved, and permissible tolerance bands for these nominal data, in which the mass-produced window glazings are each curved and each equipped with at least one profiled polymer strip comprising one (or more) insert(s), said profiled strip being produced by encapsulating glazed elements in a mold exhibiting a molding cavity, in which the mass-produced window glazings produced have a curvature which corresponds to that of the reference window glazing, within the tolerance bands, and in which said method comprises at least the steps which consist in:

A—manufacturing a collection of prototype window glazings by encapsulating glazed elements in a mold that has a molding cavity [corresponding to the nominal dimensions of the reference window glazing],
B—measuring the curvature of all the prototype window glazings of the previous step following encapsulation,
C—correcting at least one piece of hardware chosen from the following list:
i—the molding cavity of the mold, or
ii—the glazed element, or
iii—the insert or inserts,
in order to compensate for the post-encapsulation mean degrees of curvature which are too high or too low,
D—producing the mass-produced window glazings by encapsulation in a mold using the corrected hardware.

In an alternative form, step C of correcting at least one piece of hardware is performed on a piece of hardware which, prior to the correction step, is of a configuration that corresponds to the nominal dimensions for the reference window glazing.

In an alternative form, prior to the correction step C, at least one piece of hardware is of a configuration that does not correspond to the nominal dimensions for the reference window glazing.

For example, it is possible for the molding cavity of the mold not to correspond to the nominal dimensions of the reference window glazing and/or for the glazed elements not to correspond to the nominal dimensions of the reference window glazing and/or for the insert or inserts not to correspond to that or those of the reference window glazing.

It is further possible for, prior to the correction step C, none of the pieces of hardware i, ii or iii to be of a configuration corresponding to the nominal dimensions for the reference widow glazing.

One advantageous solution for correcting the molding cavity of the mold in order to compensate for the post-encapsulation mean degrees of curvature that are too high or too low is to implement the following steps in succession:
selecting a collection of identical points i in all three dimensions for all the prototype window glazings and the reference window glazing,
calculating, for the collection of prototype window glazings, the mean deviation from the nominal of the reference window glazing Pi at each point i of the curvature,
calculating the mean Qi of this deviation Pi of the point situated on the left-hand side of the longitudinal axis of the prototype window glazings (which is also the axis of forward travel of the vehicle in respect of the windshield, the rear screens and roof glazing) with the deviation Pi of its counterpart on the right-hand side of the longitudinal axis of the prototype window glazings,
calculating the deviation Ti at each point i between the nominal of the reference window glazing and the center of the permissible tolerance band at the point i,
calculating the curvature compensation at each point i of the left-hand and right-hand half-volumes using the formula: Qi-Ti.

One advantageous solution for correcting the glazed element in order to compensate for post-encapsulation mean degrees of curvature which are too high or too low is to modify bending parameters pertaining to the glazed elements prior to encapsulation, these parameters being chosen at least from the following list:
the heating configuration, both in terms of intensity and in terms of location,
the shape of the tool used to support and/or of the tool used to shape the glazed element.

One advantageous solution for correcting the insert or inserts in order to compensate for post-encapsulation mean degrees of curvature which are too high or too low, consists in modifying the shape of the insert or inserts, for example by deformation (particularly by pressing) or by shaping a new type of insert.

The present invention also relates to the device for implementing the method according to the invention, said device comprising at least:

i—the molding cavity of the mold, or
ii—the glazed element, or
iii—the insert or inserts,
which are not of a configuration that corresponds to the dimensions for the reference window glazing for a production run of window glazings.

In particular, the device comprises at least one corrected piece of hardware chosen from the following list:

i—the molding cavity of the mold, or
ii—the glazed element, or
iii—the insert or inserts,
for compensating for post-encapsulation mean degrees of curvature which are too high or too low.

The present invention also relates to the window glazings equipped with at least one profiled polymer strip comprising one (or more) insert(s), said window glazings being obtained by implementing the method according to the invention, the mass-produced window glazings produced having a curvature which corresponds to that of the reference window glazing within the tolerance bands.

These window glazings may, in the production run, be monolithic window glazings if they comprise only a single glazed element, for example made of glass, or may be multiple window glazings incorporating several glazed elements such as laminated window glazings consisting of two sheets of glass between which a sheet of a plastic, for example polyvinyl butyral is inserted.

The present invention will be better understood from reading the detailed description of a nonlimiting exemplary embodiment which follows, and from studying the attached figures:

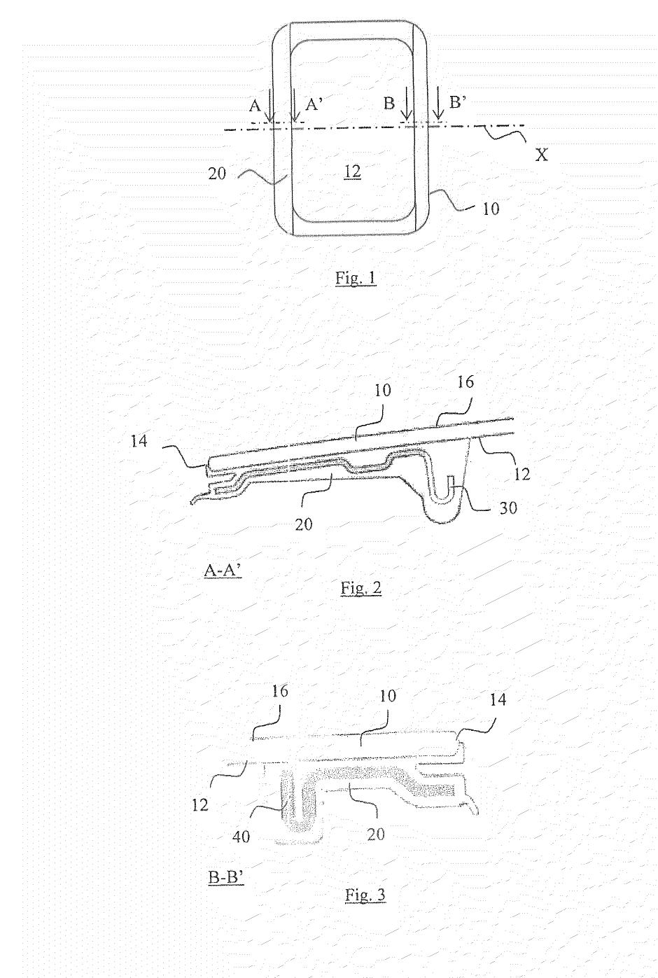

FIG. 1 illustrates a view from beneath of a motor vehicle roof glazing equipped on its interior face with an encapsulated strip;

FIG. 2 illustrates a part view in section on AA′ of FIG. 1;

FIG. 3 illustrates a part view in section BB′ of FIG. 1;

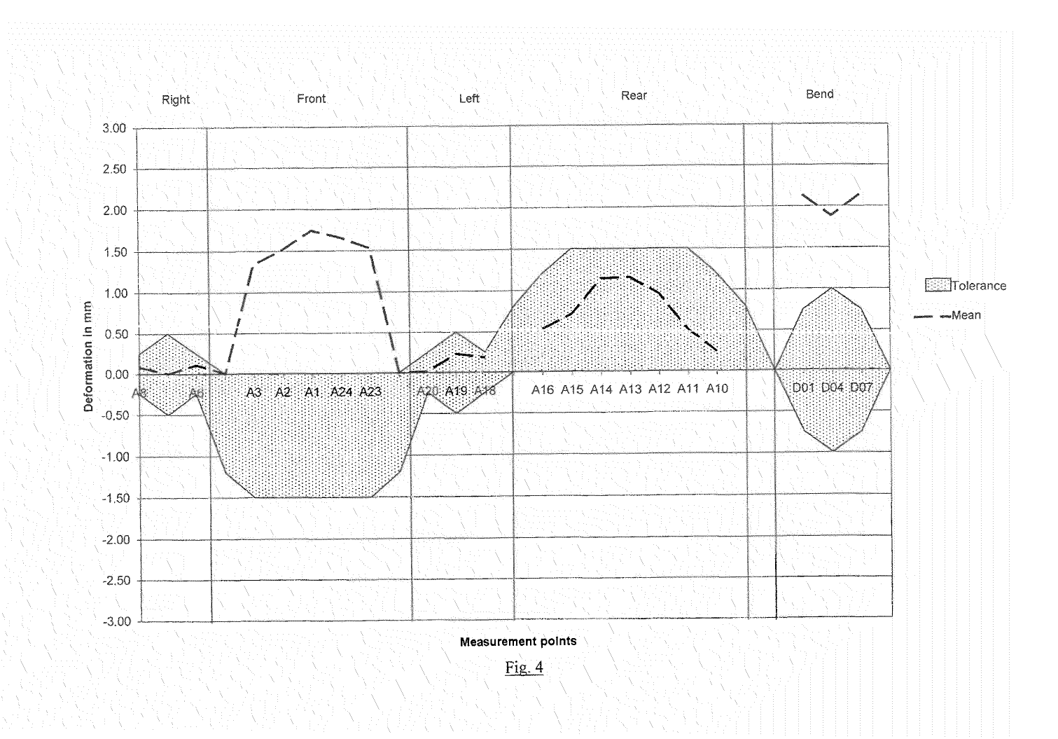

FIG. 4 illustrates mean deformation measurements for a collection of prototype window glazings at certain points on the window glazing with respect to the deformation of the reference window glazing, and the permissible tolerance zones; and

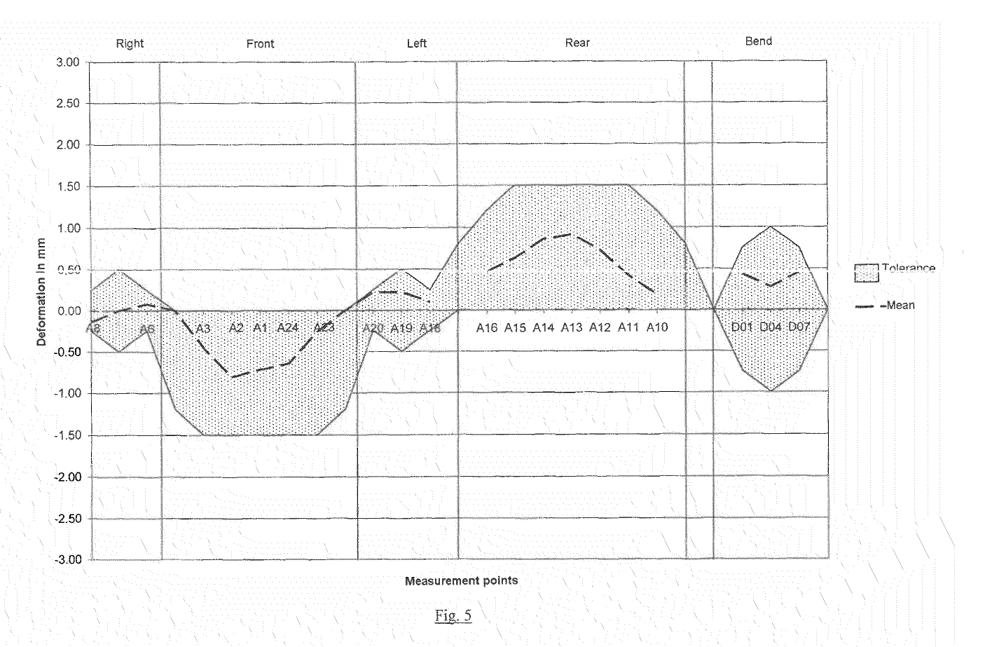

FIG. 5 illustrates the mean deformation measurements for the mass-produced window glazings at the same measurement points as in FIG. 4 with respect to the deformation of the reference window glazing, and the permissible tolerance zones.

It should be emphasized that the various elements depicted have not been drawn strictly to scale in FIGS. 1 to 3 in order to make these figures easier to understand.

The window glazing 10 illustrated in FIG. 1 is a vehicle roof glazing intended to be positioned in an aperture formed in the roof of a vehicle and more particularly of a motor vehicle.

This window glazing thus has two main surfaces, an interior surface 12 intended to be positioned toward the interior of the vehicle and, on the opposite side, an exterior surface 16, these two surfaces being separated by an edge face 14.

This window glazing also has some curvature, that is to say is not flat but has an overall deformation obtained by bending. This deformation may be produced in a plane, such as the longitudinal plane of the vehicle or a transverse plane perpendicular to this longitudinal plane. The deformation may also be performed in these two planes: this is then double curvature.

In general, the bending is performed in such a way that the window glazing maintains symmetry along the longitudinal plane of the vehicle, here illustrated by the axis X.

The window glazing illustrated in FIG. 1 is a traditional motor vehicle roof glazing of which the length along the axis X is less than the width, but could also be a motor vehicle roof glazing of the so-called “panoramic” type of which the length along the axis X matches or exceeds the width.

The window glazing 10 incorporates a glazed element made of monolithic glass, that is to say consisting of a single sheet of glass which in this instance is toughened, but could also incorporate a synthetic monolithic glazed element or multiple glazed element, that is to say one made up of several sheets of mineral or synthetic substance between which at least one layer of adhesive substance (in the case of laminated glazings) is inserted.

The thickness of the window glazing 10 in this instance is 3.85 mm.

In the case of a window glazing for a vehicle, the window glazing generally has a decorative band, not illustrated here, around at least a part of its periphery. This decorative band is generally the result of a deposition of enamel, performed on the interior face of the window glazing or on an interlayer of the window glazing in the case of multiple window glazings, but may also result from a partial and/or peripheral coloration of a sheet of material used, particularly in the case of a sheet of organic material (in the case of laminated window glazings).

The window glazing 10 is provided, over its entire periphery, in contact with the interior surface 12 and part of the edge face 14, with a profiled polymer strip 20 obtained by implementing an encapsulation step after the bending step. This strip thus has an annular shape but it is entirely possible for the profiled strip to be provided over just part of the periphery of the window glazing.

The profiled strip could also be provided only on the periphery of the exterior surface 16, possibly protruding against all or part of the thickness of the edge face 14 or alternatively on the periphery of the two main surfaces 12, 16 and of the edge face 14.

The material used here is polyurethane, but all polymer materials customarily used for encapsulation can be used here.

The profiled strip of the roof illustrated in FIG. 1 incorporates two transverse inserts, a front transverse insert 30 positioned in part of the profiled strip situated toward the front with respect to the direction of forward travel of the vehicle and illustrated in detail in FIG. 2, and a rear transverse insert 40 positioned in part of the profiled strip situated toward the rear of the vehicle and illustrated in detail in FIG. 3.

These inserts are steel reinforcing inserts and thus have an elastic modulus (or Young's modulus) of the order of 210 GPa.

Each insert is correctly positioned in the encapsulation mold by virtue of at least one and preferably two magnets situated in the bottom of the molding cavity of the mold.

These inserts are, for the most part, embedded in the material of which the profiled strip is made such that only the positioning point or points in contact with a positioning magnet situated in the mold projects (or project) (possibly into a recess of the profiled strip) out from the profiled strip.

These inserts are reinforcing inserts intended to improve the rigidity of the window glazing in the overall direction of the insert.

However, it is entirely conceivable for the inserts to protrude for the most part out from the profiled strip in such a way that the protruding parts can allow the window glazing to be fixed in an aperture of the bodywork and/or allow one or more accessories to be attached and/or to project in order to make the profiled strip more decorative.

Furthermore, because the window glazing illustrated is a traditional motor vehicle roof glazing of which the length along the axis X is less than its width, it is more sensible to increase the rigidity of the window glazing in the transverse direction; however, if the window glazing were a roof glazing of the so-called “panoramic” type, of which the length along the axis X exceeded the width, it would then obviously be more sensible to increase the rigidity of the window glazing along the longitudinal axis using longitudinal reinforcing inserts.

In FIGS. 2 and 3 it can be seen that the profiled strip 20 is fixed against the interior surface 12 of the window glazing 10, protrudes over part of the edge face 14, but does not protrude over the exterior surface 16.

However, the shape given to the profiled strip and to the inserts in FIGS. 2 and 3 is entirely arbitrary and a person skilled in the art will know how to dimension the profiled strip and the inserts in such a way as to obtain the desired effects. This is why in the subsequent figures, the shape of the profiled strip is illustrated symbolically using simple lines.

The person skilled in the art will be aware, from American patent U.S. Pat. No. 6,106,758 in particular, the content of which is incorporated herein by reference, of an encapsulation technique that involves inserting inserts into the profiled strip.

As explained above, the materials used have very different coefficients of thermal expansion:
for glass: 8.6×10⁻⁸ K⁻¹ (from 0 to 300° C.),
for steel: 1.1×10⁻⁵ K⁻¹ (from 0 to 300° C.).

Even if the injection temperature at the time of encapsulation is not very high (generally of the order of 100° C. and sometimes as high as 200° C. but rarely higher than this) and even if the injection cycle is of short duration (generally lasting of the order of 20 to 30 seconds in the case of small parts and sometimes up to one or even two minutes in the case of very large parts, but rarely longer than that), this very wide disparity in coefficients means that the window glazing will not exhibit exactly the same configuration after encapsulation as it did before encapsulation.

When a motor vehicle manufacturer designs a new model of vehicle, it provides the dimensions of a reference window glazing, that is to say it provides a definition of the overall form of the window glazing that it wishes to incorporate into that model of vehicle, specifying tolerances in the form of tolerance ranges or tolerance bands which are permissible at certain particular points.

It may happen that the tolerance bands at certain points are not centered on this point, that is to say that the tolerance on the plus side differs, in terms of absolute value, from the tolerance on the minus side. In such cases, it is not the reference window glazing as supplied by the manufacturer that is used within the meaning of this document but a so-called “nominal” window glazing corresponding to the reference window glazing with the tolerance bands recentered if necessary so that the tolerance on the plus side at every given point is identical, in terms of absolute value, to the tolerance on the minus side.

These “nominal data” within the meaning of the present invention thus denote either directly the data of the reference window glazing if the tolerance band associated with each point is balanced in such a way that at every given point the tolerance on the plus side is identical, in terms of absolute value, to the tolerance on the minus side, or the data of the reference window glazing corrected in such a way that, at every given point, the tolerance on the plus side is identical, in terms of absolute value, to the tolerance on the minus side.

In order for the mass-produced window glazings to be able thereafter to be fitted into the aperture of the bodywork on assembly lines it is of course necessary for these mass-produced window glazings to correspond to the reference window glazing give or take these tolerances.

However, a problem arises when the window glazings incorporate one or more insert(s).

When a test window glazing which corresponds to the reference window glazing with inserts corresponding to those of the reference window glazing and using an encapsulation mold comprising a molding cavity corresponding to that of the reference window glazing is encapsulated, the curvature at certain points on the window glazing may very slightly exceed the desired curvature (by the order of 0.1 to 0.3 mm) while at other points the curvature may be quite considerably greater than the desired curvature (by the order of 0.5 to 1 mm) and at some points it may even be very much greater than the desired curvature (by 1.5 up to 2.5 or even 3.5 mm).

Thus, the encapsulated test window glazing does not ultimately correspond exactly to the reference window glazing with its tolerances.

To remedy this problem, it is proposed that an entire collection of prototype window glazings be produced by encapsulating test window glazings which correspond to the reference window glazing with inserts that correspond to those of the reference window glazing and using an encapsulation mold comprising a molding cavity that corresponds to that of the reference window glazing.

This collection of prototype window glazings consists of a minimum of three and preferably at least ten window glazings. An adequate value seems to lie around the twenty mark. There seems to be no need to manufacture more than thirty prototype window glazings.

FIG. 4 illustrates the mean deformation at certain points on all the prototype window glazings, in mm, with respect to the deformation of the reference window glazing, and the permissible tolerance zones. In this figure, it can be seen that the tolerance never exceeds 1.5 mm with respect to the reference measurement.

These measurements have been taken after encapsulation, once the prototype window glazings have returned to ambient temperature (23° C.).

As can be seen in this figure, the measurements taken on the left-hand and right-hand edges of the prototype window glazings, which have no insert, fall within the tolerance zones.

The measurements taken on the rear edge of the prototype window glazings are also in the tolerance zone, but the measurements taken on the front edge are completely outside the tolerance zone and the measurements taken at the bending points (where there is a change in the direction of curvature) are also outside the tolerance zones: the window glazing is excessively curved.

In order to mass-produce the window glazing 10, a first solution thus proposes to correct the molding cavity of the encapsulation mold on the front edge of the window glazing. Because the window glazing is excessively curved in this region after encapsulation, the molding cavity can be modified in such a way as to oppose excessive curvature of the window glazing in this region.

The effectiveness of the correction is then tested by producing a new collection of prototype window glazings by encapsulating test glazings.

To mass-produce the window glazing 10 it is also possible in a second solution, as an alternative or as a supplement to the first solution, to use, prior to encapsulation, window glazings that do not correspond to the reference window glazing these window glazings being:
either too highly curved at the points where it was found that the post-encapsulation test window glazings were not curved enough,
or not curved enough at the points where it was found that the post-encapsulation test window glazings were excessively curved.

In order to mass-produce the window glazing 10 it is also possible in a third solution, as an alternative or as a supplement to the first solution and/or the second solution, to use, prior to encapsulation, inserts which do not correspond to those normally used for the reference window glazing, these inserts being:
either excessively curved at the points where it was found that the post-encapsulation test window glazings were not curved enough,
or not curved enough at the points where it was found that the post-encapsulation test window glazings were excessively curved.

Inserts which do not correspond to those normally used for the reference window glazing may be produced for example by modifying, by pressing, inserts normally used for the reference window glazing or by instigating the manufacture of new inserts different than those normally used for the reference window glazing.

If certain mean measurements are still outside the tolerance zone, then a further correction can be made to the molding cavity of the mold and/or to the window glazings prior to encapsulation and/or to the inserts prior to encapsulation.

To compensate for post-encapsulation mean degrees of curvature that are too high or too low, the following steps are performed in succession:
calculating the mean of the deviation from the nominal Pi at each point i on the curvature for all of the collection of prototype window glazings,
calculating the deviation Pi at each point i with respect to the reference window glazing and calculating the mean Qi of this deviation of the point i situated on the left-hand side of the longitudinal axis of the prototype window glazings with the deviation of its counterpart on the right-hand side of the longitudinal axis of the prototype window glazings,
calculating the deviation Ti at each point i from the nominal to the center of the tolerance band, and
calculating the compensation in curvature at each point i of the left-hand and right-hand half-volumes using the formula: Qi-Ti.

This method splits the left side and right side measurements in order to allow ultimately a compensation to be calculated that is symmetric with respect to the longitudinal axis of the window glazings.

In the foregoing, the present invention is described by way of example. It must be understood that a person skilled in the art is capable of varying the invention in various ways without in any way departing from the scope of the patent as defined by the claims.

The present invention is particularly applicable to any motor vehicle window glazing and to any window glazing provided that it is curved and equipped with a portion of encapsulated profiled strip incorporating at least part of an insert.

1-17. (canceled)

18. A method for mass-production of window glazings using nominal data defining a reference window glazing that is curved, and permissible tolerance bands for the nominal data, in which the mass-produced window glazings are each curved and each includes at least one profiled polymer strip including at least one or more insert, the profiled strip being produced by encapsulating a glazed element in a mold exhibiting a molding cavity,
in which the mass-produced window glazings produced have a curvature that corresponds to that of the reference window glazing, within the tolerance bands,
and in which, in the production run, for each window glazing of the production run, at least
i) the molding cavity of the mold, or
ii) the glazed element, or
iii) the at least one insert,
is not of a configuration that corresponds to dimensions for the reference window glazing.

19. The production method as claimed in claim 18, in which, in the production run, for each window glazing, the molding cavity of the mold is not of a configuration that corresponds to the dimensions for the reference window glazing.

20. The production method as claimed in claim 18, in which, in the production run, for each window glazing, the glazed element is not of a configuration that corresponds to the dimensions for the reference window glazing.

21. The production method as claimed in claim 18, in which, in the production run, for each window glazing the at least one insert is not of a configuration that corresponds to the dimensions for the reference window glazing.

22. The production method as claimed in claim 18, in which, in the production run, for each window glazing, the molding cavity of the mold and the glazed element are not of a configuration that corresponds to the dimensions for the reference window glazing.

23. The production method as claimed in claim 18, in which, in the production run, for each window glazing, the molding cavity of the mold and the at least one insert is not of a configuration that corresponds to the dimensions for the reference window glazing.

24. The production method as claimed in claim 18, in which, in the production run, for each window glazing, at least the glazed element and the at least one insert is not of a configuration that corresponds to the dimensions for the reference window glazing.

25. The production method as claimed in claim 18, in which, in the production run, for each window glazing, the molding cavity of the mold, the glazed element, and the at least one insert is not of a configuration that corresponds to the dimensions for the reference window glazing.

26. The production method as claimed in claim 18, comprising:
a) manufacturing a collection of prototype window glazings by encapsulating glazed elements in a mold that has a molding cavity;
b) measuring the curvature of all the prototype window glazings of the a) manufacturing following encapsulation;
c) correcting at least one piece of hardware chosen from:
i) the molding cavity of the mold, or
ii) the glazed element, or
iii) the at least one insert,
to compensate for post-encapsulation mean degrees of curvature that are too high or too low; and
d) producing the mass-produced window glazings by encapsulation in a mold using the corrected hardware.

27. The production method as claimed in claim 26, in which the c) correcting at least one piece of hardware is performed on a piece of hardware which, prior to the correcting, is of a configuration that corresponds to the nominal dimensions for the reference window glazing.

28. The production method as claimed in claim 26, in which prior to the c) correcting, at least one piece of hardware is of a configuration that does not correspond to the nominal dimensions for the reference window glazing.

29. The production method as claimed in claim 26, in which prior to the c) correcting, none of pieces of hardware i), ii), or iii) is of a configuration that corresponds to the nominal dimensions for the reference window glazing.

30. The production method as claimed in claim 26, in which, to correct the molding cavity of the mold to compensate for the post-encapsulation mean degrees of curvature that are too high or too low, the following are performed in succession:
selecting a collection of identical points in all three dimensions for all the prototype window glazings and the reference window glazing;
calculating, for the collection of prototype window glazings, mean deviation from the nominal of the reference window glazing at each point of the curvature;
calculating mean Qi of deviation of a point situated on a left-hand side of the longitudinal axis of the prototype window glazings with deviation of its counterpart on a right-hand side of the longitudinal axis of the prototype window glazings;
calculating deviation Ti at each point between the nominal of the reference window glazing and the center of the permissible tolerance band it the point; and
calculating the curvature compensation at each point of the left-hand and right-hand half-volumes using the formula. Qi-Ti.

31. The production method as claimed in claim 26, in which, to correct the glazed element to compensate for the post-encapsulation mean degrees of curvature that are too high or too low, bending parameters pertaining to the glazed elements are modified, these parameters chosen at least from:
heating configuration, both in terms of intensity and in terms of location; shape of a tool used to support and/or of a tool used to shape the glazed element.

32. The production method as claimed in claim 26, in which, to correct the at least one insert to compensate for post-encapsulation mean degrees of curvature that are too high or too low, the shape of the at least one insert is modified.

33. A device for implementing the method as claimed in claim 18, the device comprising:
i) the molding cavity of the mold, or
ii) the glazed element, or
iii) the at least one insert,
which are not of a configuration that corresponds to the dimensions for the reference window glazing for a production run of window glazings.

34. Window glazings comprising at least one profiled polymer strip comprising:
at least one insert, the window glazings being obtained by implementing the method as claimed in claim 18, the mass-produced window glazings produced having a curvature that corresponds to that of a reference window glazing within the tolerance bands.
